(19) United States
(12) Patent Application Publication
(10) Pub. No.: US 2024/0231455 A1
(43) Pub. Date: Jul. 11, 2024

(54) SYSTEM LEVEL ADAPTIVE DTR CONTROL MECHANISM TO EXTEND DYNAMIC TEMPERATURE RANGE

(71) Applicant: Intel Corporation, Santa Clara, CA (US)

(72) Inventors: Manish SHARMA, Bangalore (IN); Vikas MISHRA, Chandler, AZ (US); Richard Marian THOMAIYAR, Trichy (IN); Vikram BODIREDDY, Keelpudur (IN); Ashraf JAVEED, Bangalore (IN); Satish MUTHIYALU, Bangalore (IN)

(21) Appl. No.: 18/558,180

(22) PCT Filed: Sep. 1, 2021
(86) PCT No.: PCT/US21/48751

§ 371 Date: Oct. 30, 2023

(51) Int. Cl. G06F 1/20

(52) U.S. Cl. CPC G06F 1/206

(57) ABSTRACT

Apparatus and methods for implementing an adaptive Dynamic Temperature Range (DTR) control mechanism to extend dynamic temperature range. A DTR control manager is provided to initiate retrain/recalibrate high-speed IO (input-output) links without link reset and extend the dynamic temperature range to the entire operating range based on thermal and other conditions. The DTR control manager ensures optimized retraining/recalibration of the link, which is based on system level parameters (like ambient temperature, fan speed, thermal zone of the devices etc.) and other environmental conditions. In some embodiments the mechanism or algorithm of the DTR control manager can be implemented in a BMC (Baseboard Management controller) or the like and hence enables the adaptive DTR solution in an operating system (OS) agnostic and seamless manner.

### BACKGROUND INFORMATION

An SoC (System on a Chip), such as a server processor, supports certain ambient operating temperature range (TaOTR) based on its application. For example, the temperature range for an industrial part is generally −40° C. to +85° ° C. or extended temperature (eTemp) range could be −40° C. to +105° ° C. (AEC-Q100 grade-2) or −40° C. to +150° C. (AEC-Q100 Grade-0). However, many of the high-speed IPs/SoCs require a reset when the temperature is varied during normal functionality beyond a certain limit, which defeats the purpose of the wide Ambient Temperature Range. It is important for any device to be functional throughout the full range of supported temperature, which is defined by the term “Dynamic Temperature Range” or DTR.” Ideally, the device/silicon should be functional throughout the temperature range without sacrificing any functionality or reset: that is (TaOTR)=(TDTR).

The DTR of some SoCs is much lower than the system operating temperature range as explained above, which makes these devices unfit for many applications, especially in the Edge or Automotive segments. Different IPs (Intellectual Property blocks) in an SoC may support different DTR values based on the respective PHY (Physical Layer) architecture. For example, despite supporting recalibration by PCIe (Peripheral Component Interconnect Express) 4.0, the supported DTR for some SoCs is limited to just 90° C., which limits their adaption in the Edge/Telco Network segment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a high level architecture block diagram illustrating selected components and aspects of an adaptive DTR control mechanism and system, according to one embodiment:

FIG. 2 is a DTR high level information flow diagram, according to one embodiment;

FIG. 3 is a high-level flow diagram for a link retrain request and indication, according to one embodiment:

FIG. 4 is a diagram illustrating an example of how retrain/recalibration may be triggered without a link reset:

FIG. 5 is a die temperature graph comparing error margin vs. temperature with and without system level adaptive link recalibration;

FIG. 6 is a diagram illustrating an adaptive retrain/recalibration during lean data transfer periods:

FIG. 7 is diagram illustrating an example of utilization of adaptive link training profiles:

FIG. 8 is timeline graphic illustrating an example of staggered link retrain/recalibration managed by a DTR manager; and

FIG. 9 is a block diagram illustrating a computing platform/system in which aspects of the embodiments disclosed herein may be implemented.

### DETAILED DESCRIPTION

Embodiments of apparatus and methods for implementing an adaptive DTR control mechanism to extend dynamic temperature range are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments described and illustrated herein, a DTR control manager is provided to initiate retrain/recalibrate high-speed IO (input-output) links without link reset and extend the dynamic temperature range to the entire operating range based on thermal and other conditions. In one aspect, the existing framework of PHY recalibration is leveraged (like TCRH or Receive error-margin recalibration in PCIe PHY) and enables the recalibration based on the system level parameters as part of close-loop control and management algorithm. The DTR control manager ensures optimized retraining/recalibration of the link, which is based on system level parameters (like ambient temperature, fan speed, thermal zone of the devices etc.) and other environmental conditions. In some embodiments the mechanism or algorithm of the DTR control manager can be implemented in a BMC (Baseboard Management controller) or the like and hence enables the adaptive DTR solution in an operating system (OS) agnostic and seamless manner.

### Architecture Block Diagram

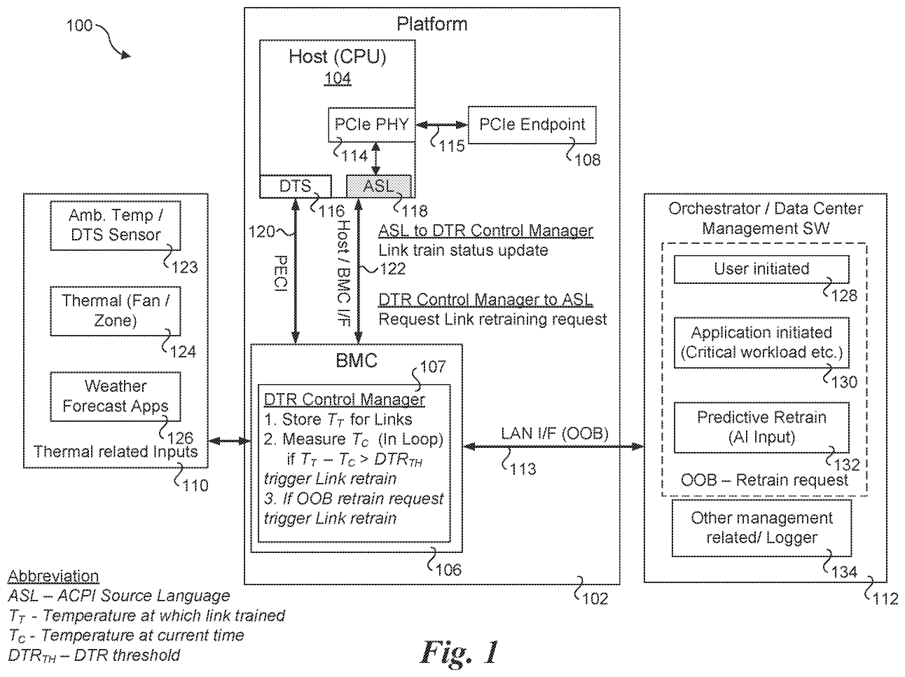

FIG. 1 shows a high level architecture block diagram 100 illustrating selected components and aspects of an adaptive DTR control mechanism and system, according to one embodiment. The architecture includes a platform 102 having a host CPU 104 coupled to a BMC 106 including a DTR control manager 107 and a PCIe endpoint 108. BMC 106 receives thermal related inputs 110 and interfaces with an orchestrator/data center management (DCM) software 112 over an out-of-band (OOB) LAN interface 113.

Host 104 includes a PCIe PHY 114, an on-die digital thermal sensor (DTS) 116, and an ACPI Source Language (ASL) interface 118 that is configured to parse and interpret ASL code. PCIe endpoint device 108 is connected to PCIe PHY 114 via a PCIe link 115. BMC 106 receives measurements from DTS 116 over a Platform Environment Control Interface (PECI) 120. ASL interface 118 is connected to BMC 106 over a Host/BMC interface 122. As illustrated, a link training status update if provided from ASL interface 118 to DTR controller manager 107, while a request link retraining request is provided from DTR controller manager 107 to ASL interface 118.

BMC 106 is configured to monitor thermal related inputs 110 to determine and characterize the temperature range at which Link Retrain has happened, and continuously measure current temperature for DTR to determine the acceptable DTR range, before which Link Retrain is to be initiated. Thermal related inputs may generally include various inputs relating to thermal conditions and the like. Non-limiting examples shown in FIG. 1 include an ambient temperature and/or DTS sensor 123 for providing an inlet temperature, a thermal fan speed and/or zone temperature input 124, and input 126 from one or more weather forecast applications.

DTR control manager 107 provides a Link Training status indication, which is an operating system (OS) agnostic way of indicating the Link Training status to BMC 106 through ASL code. Based on an OS-directed configuration and Power Management (OSPM) indication, an ASL method can update the Link Training status from Link Status Register (offset 12h) of the PCIe specification. On receiving the same, BMC 106 will mark the current temperature as T_{T} (Temperature at which link trained) and will be used to measure the acceptable DTR range. Optionally, an initial temperature value for T_{T} may be obtained through various other means.

When a difference between T_{C} (Temperature at current time) and T_{T} exceeds a dynamic temperature range threshold (T_{T}−T_{C}>DTR_{TH}), then BMC 106 can trigger Link retraining through ASL, which in one embodiment will set the “Retrain Link—Bit 5” in Link Control Register (offset 10h) of the PCIe specification, causing the device link to be retrained. BMC 106 will check the success of the Link retrain, by monitoring the Link training status from ASL, and accordingly mark the new temperature as and updated T_{T} of the PCIe endpoint device. This new temperature will be used to determine the acceptable DTR range (and DTR_{TH}), and DTR control manager 107 in BMC 106 will initiate Link retraining when T_{T}−T_{C}>DTR_{TH}. Generally, the value for DTR_{TH} may be the same or differ depending on T_{C} and/or other factors.

Orchestrator/DCM software 112 is used to provide various inputs to and receive various outputs from BMC 106. The inputs include an OOB retrain request comprising one or more of user initiated retrain request 128, an application initiated retrain request 130, and a predictive retrain request 132. Orchestrator/data center management software 112 also includes provisions for logging various DTR data and provide other management related functions.

Under an aspect of predictive training 132, DTR control manager 107 will accept an OOB request to trigger Link Retrain/Recalibrate. Orchestration/DCM software 112 can rely on environmental conditions to determine the project operating range, and accordingly retrain before performing any critical workload execution. For example, this may include consideration of:
1. Environment (Weather)—Can rely on weather forecast and time of day to determine the upcoming ambient temperature and workload and perform retrain at best optimal time.
2. Workload—Orchestration software can initiate retrain before performing any critical workload or high execution workload, which can increase the Platform temperature, thereby DTR range will not be exceeded during the workload lifetime.

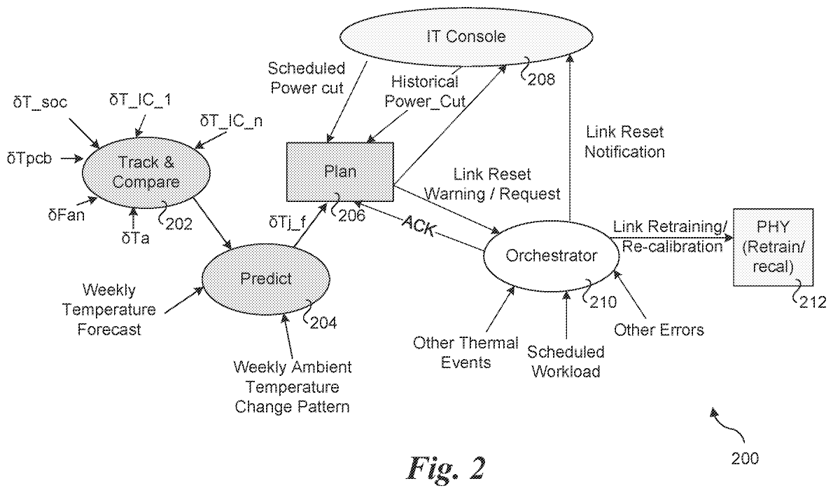

FIG. 2 shows a DTR high level information flow diagram 200. The components include a track & compare block 202, a predict block 204, a plan block 206, and IT (information technology) console 208, and an orchestrator 210.

Thermal Related Inputs are provided to track and compare block 202, which monitors a change (delta or δ) in temperature or other thermal related parameters, where:

$$δ Ta = change in ambient temperature$$

$$δ Fan = change in Fan status$$

$$δ Tpcb = change in printed circuit board temperature$$

$$δT\_soc = change in SoC temperature$$

$$δT\_IC \_ 1 = change in temperature of a first integrated circuit$$

$$δT\_IC \_N = change in temperature of a n {N}^{th} integrated cicruit$$

These changes in temperature or other thermal related parameters are provided an in input to predict block 204 in which predictive retrain logic 132 is implemented. Other inputs to predict block 204 includes weekly temperature forecast and weekly ambient temperature change patterns.

Predict block 204 processes its inputs and outputs a change in forecast of junction temperature (δTj_f) signal to plan block 206. Plan block 206 also receives a schedule power cut input and a historical power cut input from IT console 208. In view of the inputs, plan block 206 generates a plan for managing the link. It also coordinates with orchestrator 210 by sending a link reset warning/request and receiving an ACKnowledgement of the warning/request from orchestrator 210.

As shown, orchestrator 210 receives inputs including other thermal events, scheduled workloads, and other errors. Orchestrator 210 provides a link retraining/recalibration signal to perform PHY retrain/recalibration 212. Orchestrator 210 also sends a link reset notification to IT console 208.

### High Level Flow

In one embodiment, all high-speed interfaces are trained/calibrated at system boot. The DTR control manager logs T_{T}, e.g., system temperatures at current time (like SoC temperatures (DTS), ambient temp and PCB temp) through existing sensors. The DTR control manager continues to track changes in system temperature T_{C}.

When temperature change exceeds an IT admin (user) defined Warning Threshold, DTR control manager sends a notification to User/management SW (e.g., Data Center Manager (DCM)).

When the T_{C} and T_{T} difference exceeds the dynamic temperature range threshold (T_{C}−T_{T}>DTR_{TH}) then the high-speed interface may reach a marginal operating condition that may lead to link failure or otherwise the link will begin to operate outside the specified limitations for the link protocol. Hence, the DTR control manager will trigger high-speed interface link retraining/recalibration without link reset (using existing methodologies) and sends corresponding link status data to User/management software. This ensures the full capability of the link and no in-flight packets are dropped as link retraining/recalibration is performed before the margin falls below the operating range.

In one embodiment, there is an option to log a warning event and send a notification to User or Management software. This can be exercised through a warning threshold configuration by the User.

The DTR control manager can assist to proactively trigger or defer link retrain using a predictive retrain algorithm based on multiple user defined parameters (e.g., ambient temperature change pattern, scheduled maintenance, power cuts or coolant failure, etc.) Weather apps may provide expected weather changes (season, cyclone, expected temperature and humidity swings) which may be used by DTR control manager to decide on Link Retrain requirement and scheduling.

In one embodiment, an Application/Workload aware retrain algorithm assists in deciding retrain requirements based on workloads. For example, if a time critical workload is to be started that would need the link active for a defined time and a temperature change is nearing an error threshold, the DTR control manager may prepone the link retrain activity.

Generally, the link retrain information is available to an IT/System admin/Management Application to manage the various devices.

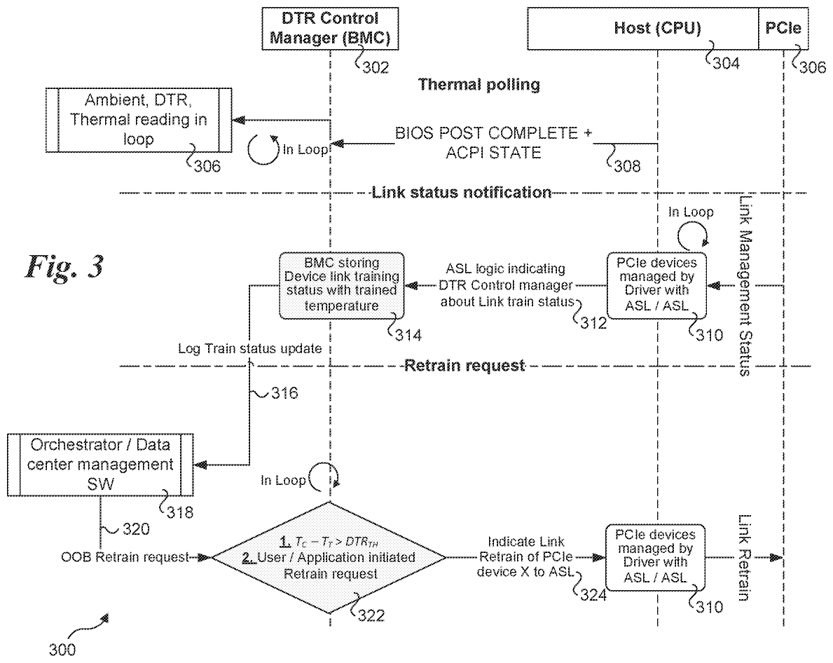

FIG. 3 shows a high-level flow diagram 300 for a link retrain request and indication. The components involved in the flow include DTR control manager 302, Host 304, and PCIe interface 306. The flow begins with a thermal polling phase, which initiates with platform boot and continues during runtime operations. DTR control manager 302 performs a polling loop to read various thermal inputs, as illustrated by a process 306. Upon BIOS reaching it POST state and an ACPI state being ready, host 304 sends a corresponding message 308 to indicate this state has been reached. At this stage, link status notification is available.

PCIe interface 306 stores a link management status in link status register 0x12 (as defined by the current PCIe specifications). As depicted in a block 310, the PCIe devices in the system are managed by associated PCIe device driver(s) with ASL. Block 310 uses a polling loop to read the PCIe interface link status register, and provides a message 312 comprising ASL logic to inform DTR control manager 302 of the current link train status.

As shown in a block 314, the BMC stores the PCIe device link train status with the trained temperature obtained above. DTR control manager 302 then provides a message 316 containing a train status log update to Orchestrator/DCM software 318.

In view of the train status update and/or other inputs (not shown), Orchestrator/DCM software 318 may issue an OOB retrain request 320 to DTR control manager 302. As depicted by a decision block 322, in a first operation DTR control manager 302 determines whether T_{C}−T_{T}>DTR_{TH}. Decision block 322 also shows a second determination to whether OOB retrain request 320 is a User or Application initiated retrain request.

If either of 1 or 2 is TRUE, DTR control manager 302 sends a message 324 to block 310 on host 304 indicating link retrain of an applicable PCIe device is to be initiated, wherein message 324 uses ASL code to instruct block 310 to initiate the link retrain. In response to receiving message 324, block 310 initiates a link retrain operation by programming link control register 0x10 in the PCIe PHY.

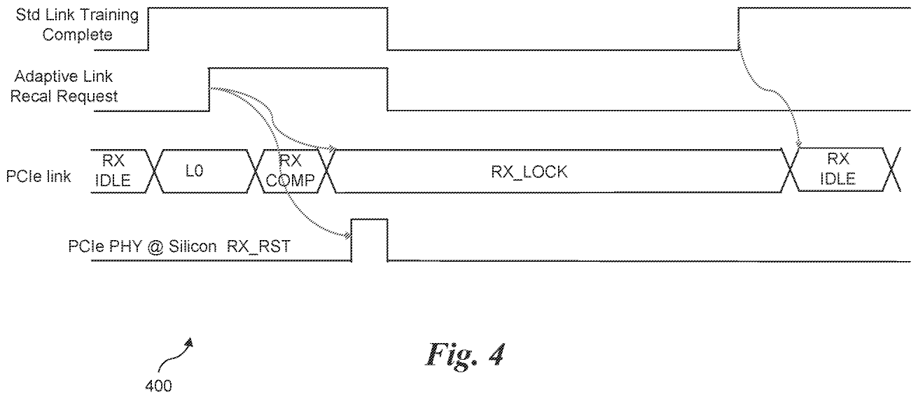

FIG. 4 shows a diagram 400 illustrating an example of how retrain/recalibration may be triggered without a link reset. The Receiver is kept in Receive-Lock state and RXPHY (the receiver PHY) is recalibrated during this phase. Once completed, the Receiver is changed from RX_LOCK to RX IDLE state. This ensures no impact to the PCIe endpoint device as it does not go through a link reset. In one embodiment, this activity is completed in <200 us as per the timeline allowed by the current PCIe specifications.

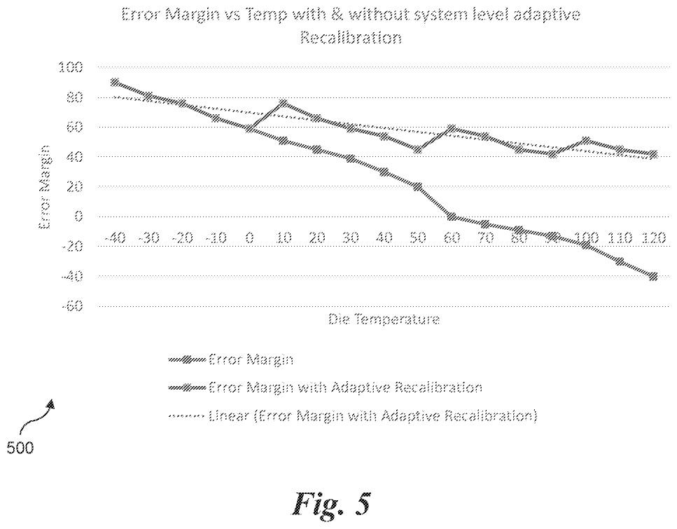

FIG. 5 shows a diagram 500 comprising a die temperature graph comparing error margin vs. temperature with and without system level adaptive link recalibration. As shown, under the conventional approach the error margin will cross 0° C. when the die temperature reaches about 60° C. Conversely, under the adaptive recalibration approach in accordance with the embodiments described and illustrated herein, the error margin is maintained above approximately 40° C. Moreover, as illustrated in FIG. 5, the system level DTR may be extended to the full operating range (e.g., die temperature from −40 to 120° C.).

Diagram 500 further shows different link retrain trigger points at different die temperatures, depending on the current die temperature. For example, the initial trigger point for link recalibration occurs when the error margin hits 60° C. Subsequently, the error margin trigger point for recalibration is approximately 40° C.

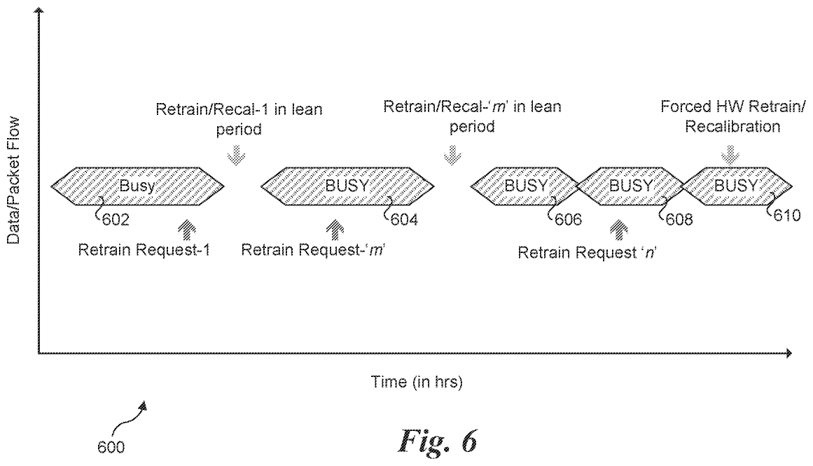

FIG. 6 shows a diagram 600 illustrating an adaptive retrain/recalibration during lean data transfer periods. This avoids surprise link downs and enables predictable system performance. In one embodiment, if there is no lean period and DTR control manager determines that an interface must go under retrain/recalibration, this will be enforced based on standard hardware logic.

During a first busy period 602 (e.g., the link is being utilized to consume a significant portion of its bandwidth or otherwise utilization is above a threshold), a first link retrain request condition is detected. Rather than immediate request a link retrain, the adaptive logic monitors the link utilization and initiates a first link recalibration upon detection of a lean period (e.g., link utilization falls below the threshold and/or the link is idle).

Following completion of the first recalibration, this cycle is repeated multiple times, including an m^{th} retrain request for a corresponding link retrain condition detected during a busy period 604 and recalibration during an m^{th} lean period. Next, there are three busy periods 606, 608, and 610 back-to-back. During busy period 608 an n^{th} retrain request condition is detected. After monitoring for and not detecting a lean period, a forced hardware retrain and recalibration procedure is initiated and performed during busy period 610.

In some embodiments, the adaptive on-demand link retrain mechanism may extend DTR based on environment and workload conditions through the OOB interface. For example, environmental conditions may include anticipated increase in temperature due to coolant failure (including Power failure such as for Edge systems, etc.) or other types of system failures that may affect cooling. Environmental conditions may also include forecast of temperature based on time of day.

Examples of workload conditions including critical workload execution. Under this consideration, the link is retrained (using the current temperature measurements) if it is anticipated the workload execution will exceed the DTR range. Another workload condition is mode selection, such as Turbo/High performance, etc. For example, suppose the driver selects turbo mode (for the CPU), and hence more data needs to be analyzed and temperature mostly exceeds the DTR range, retraining at new temperature, during this selection will provide a benefit.

The adaptive link retrain mechanism may also collect and maintain adaptive link training profiles for individual IO Interfaces (CXL, PCIe, USB3, etc.) and Ports (PCIe x4 to Ethernet, PCIe x16 to GPU, etc.) as per link capability and DTR requirements. For example, an Ethernet Port may need link retrain/recalibration at 50° C. DTR whereas a GPU Port may need link retrain/recalibration at 70° C. DTR. This interface difference can be maintained and managed through individual adaptive link training profiles.

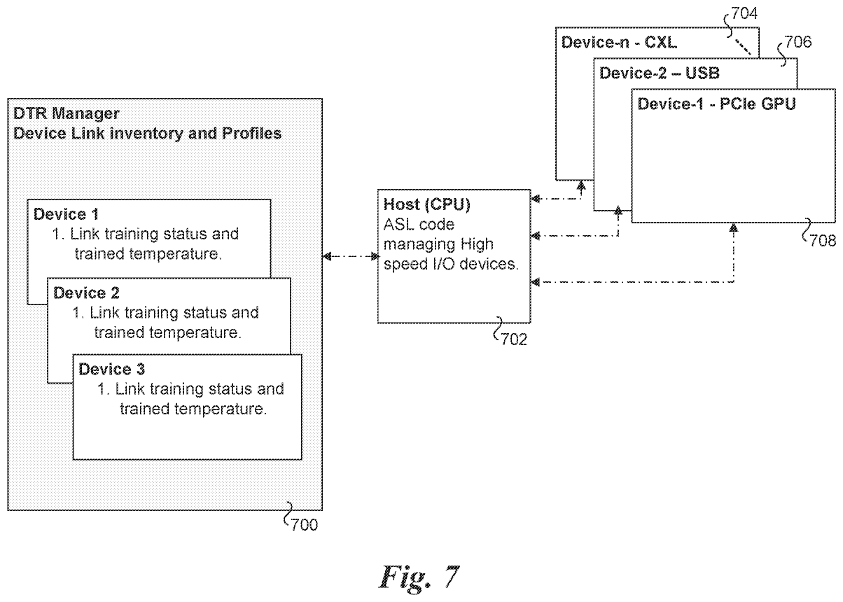

An example of utilization of such adaptive link training profiles is shown in FIG. 7. The DTR manager maintains device link inventory and profiles 700. In this example there are device link inventory and adaptive link training profiles for three Devices 1, 2, and 3. This information is exchange between the DTR manager and the host CPU using messaging including ASL code to manage the PCIe devices, as depicted in a block 702. The example PCIe interfaces/links including a 4-lane (4×) CXL (Compute Express Link) interface/link 704, a 4×USB interface/link 706, and a x4 GPU interface/link 708.

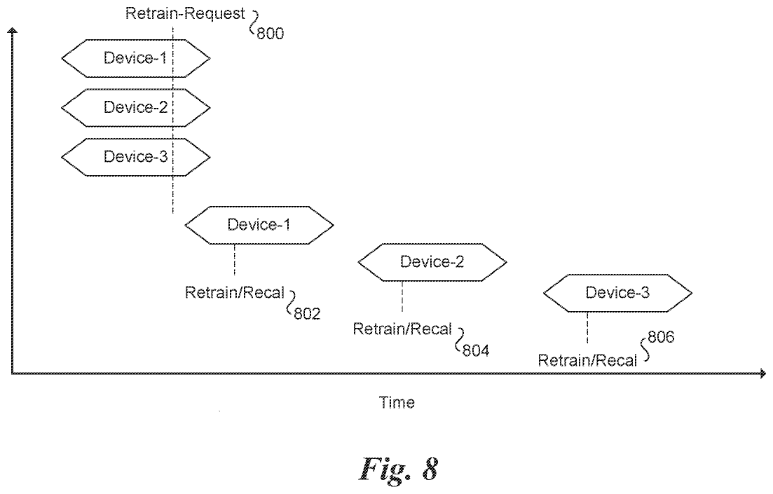

FIG. 8 shows an example of staggered link retrain/recalibration managed by a DTR manager. As illustrated, a retrain request 800 is provided to each of Device-1, Device-2, and Device-3. However, rather than immediately initiate the retrain/recalibration process for the three devices, separate staggered retrain/recalibration signals 702, 704, and 706 are provided to initiate retrain/recalibration for Device-1, Device-2, and Device-3, respectively. Staggered link retrain/recalibration may be used if required by the system design and/or based on individual device profiles.

### Example Platform/System

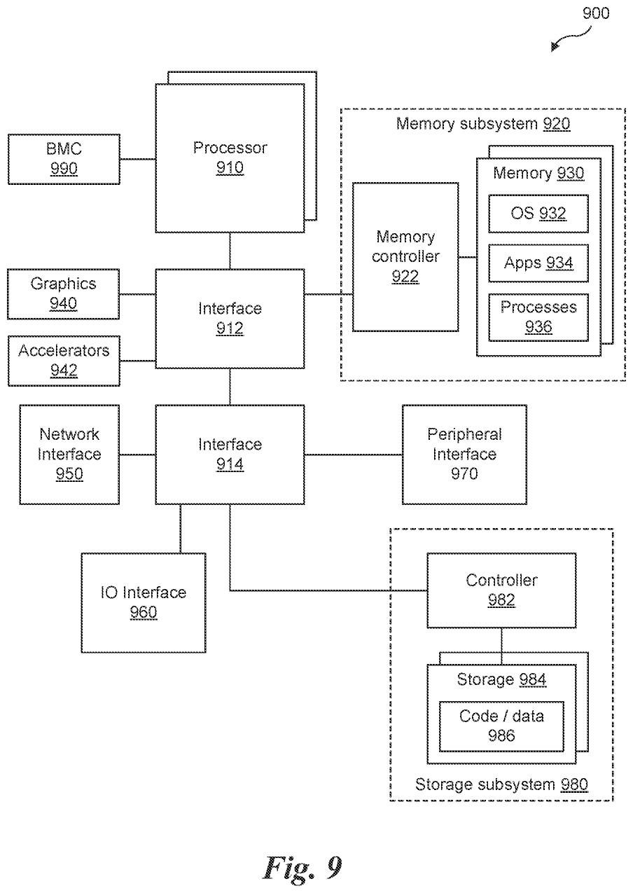

FIG. 9 depicts a computing platform 900 (also generally referred to as a computing system) in which aspects of the embodiments disclosed above may be implemented. Computing platform 900 includes one or more processors 910, which provides processing, operation management, and execution of instructions for computing platform 900. Processor 910 can include any type of microprocessor, central processing unit (CPU), graphics processing unit (GPU), processing core, multi-core processor or other processing hardware to provide processing for computing platform 900, or a combination of processors. Processor 910 controls the overall operation of computing platform 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, computing platform 900 includes interface 912 coupled to processor 910, which can represent a higher speed interface or a high throughput interface for system components that needs higher bandwidth connections, such as memory subsystem 920 or optional graphics interface components 940, or optional accelerators 942. Interface 912 represents an interface circuit, which can be a standalone component or integrated onto a processor die. Where present, graphics interface 940 interfaces to graphics components for providing a visual display to a user of computing platform 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

In some embodiments, accelerators 942 can be a fixed function offload engine that can be accessed or used by a processor 910. For example, an accelerator among accelerators 942 can provide data compression capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of computing platform 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in computing platform 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for computing platform 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

While not specifically illustrated, it will be understood that computing platform 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, computing platform 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides computing platform 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. Various embodiments can be used in connection with network interface 950, processor 910, and memory subsystem 920.

In one example, computing platform 900 includes one or more IO interface(s) 960. IO interface 960 can include one or more interface components through which a user interacts with computing platform 900 (e.g., audio, alphanumeric, tactile/touch, or other interfacing). Peripheral interface 970 can include any hardware interface not specifically mentioned above. Peripherals refer generally to devices that connect dependently to computing platform 900. A dependent connection is one where computing platform 900 provides the software platform or hardware platform or both on which operation executes, and with which a user interacts.

In one example, computing platform 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to computing platform 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to computing platform 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014), HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Computing platform further includes a BMC 990. Generally, BMC 990 may be configured similar to the BMCs described above and illustrated herein, and includes a DTR Control Manager. A BMC includes one or more processing elements, such as a processor, microcontroller, core, etc. DTR control manager may be implemented with various types of embedded logic including software/firmware that is executed on a processing element on a BMC, pre-programmed logic (e.g., an application specific integrated circuit (ASIC)) or programmable logic through use of a programmable logic device such as but not limited to a Field Programmable Gate Array (FPGA).

In an example, computing platform 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

In addition to implementing adaptive link retrain/recalibration mechanisms for computing platforms with CPUs, the teaching and principles disclosed herein may be applied to Other Processing Units (collectively termed XPUs) including one or more of Graphic Processor Units (GPUs) or General Purpose GPUs (GP-GPUs), Tensor Processing Unit (TPU) Data Processor Units (DPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

In addition to air cooling and systems using coolants, other cooling methods may be used including but not limited to emersion cooling, cold plates, and heat pipes. In these cases, means will be provided to detect whether the cooling components are operating correctly and provide associated status data.

The principles and teachings disclosed herein provide several advantages. The advantages include:
Dynamic temperature is extended, thus avoiding a silicon change or need of complex thermal/heating solutions.
Dynamic temperature range can be extended all the way to full operating range, enabling existing silicon to meet segment specific temperature range requirements.
Simplified product design and cost.
IT aware Link Management solution enables Admin to schedule re-trainings and downtime.
Enables platform/system to be available for critical workload execution based on environment conditions and workload usage.
DTR Control manager ensures seamless functionality of platform and the implementation is OS agnostic.
Minimizes the DTR dependency on high-speed IO channel loss due to board specific implementations.
Enables adaptive on-demand link retrain mechanism based on environment & workload conditions through an OOB interface.
Triggers PHY to retrain based on adaptive link training profiles for individual IO Interfaces (CXL, PCIe, USB3 etc.) and Ports (PCIe x4 to Ethernet, PCIe x16 to GPU, etc.) as per Link Capability and DTR requirements.

In addition to being deployed in data centers and server farms, the embodiments disclosed herein may be deployed in other environments and structures, including but not limited to base stations, micro data centers, and in content delivery stations.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘m’ and ‘n’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (e.g., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B: C: A and B; A and C: B and C: or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1.-20. (canceled)

21. A method for extending a dynamic temperature range of a processor including an input-output (IO) interface coupled to a device via an IO link, comprising:
monitoring one or more of temperature, environmental, and workload conditions to determine or predict that the IO link may be approaching a marginal operating condition; and
in response to determining or predicting that the IO link may be approaching the marginal operating condition, triggering at least one of retraining and recalibrating of the IO link without resetting the IO link.

22. The method of claim 21, wherein triggering the at least one of retraining and recalibration of the IO link comprises:
obtaining a processor temperature T_{T} at which the input-output (IO) link was trained;
monitoring a current temperature T_{C} of the processor; and
determining a difference between T_{T} and T_{C} is greater than a current dynamic temperature range threshold DTR_{TH}.

23. The method of claim 22, further comprising:
setting T_{T} to T_{C};
setting the current value of DTR_{TH} to a prior value or new value; and
determining a difference between T_{T} and T_{C} is greater than the current value of DTR_{TH}; and
triggering a second at least one of retraining and recalibration of the IO link.

24. The method of claim 21, further comprising:
in response to receiving a trigger for at least one of retraining and recalibrating the IO link;
monitoring a link utilization level; and
when the link utilization level falls below a threshold, initiating at least one of retraining and recalibrating the IO link.

25. The method of claim 21, wherein triggering the at least one of retraining and recalibration of the IO link comprises:
projecting an anticipated increase in a temperature of the processor in consideration of at least one of a coolant failure and one or more thermal inputs; and
in response thereto, triggering the at least one of retraining and recalibrating the IO link.

26. The method of claim 21, wherein triggering the at least one of retraining and recalibration of the IO link comprises:
monitoring one or more workload conditions;
determining a workload condition will cause the processor temperature to exceed a temperature threshold, and
in response thereto, triggering the at least one of retraining and recalibrating the IO link.

27. The method of claim 21, wherein the method is implemented on a platform including the processor and a plurality of devices coupled to the processor via respective IO links, each IO link coupled to a respective pair of IO interfaces on the device and the processor, each of the plurality of devices having a respective port, further comprising:
implementing individual adaptive link training profiles for individual IO interfaces and ports based on link capability and dynamic temperature range requirements.

28. The method of claim 21, wherein the method is implemented on a platform including the processor coupled to a management controller, further comprising:
implementing a dynamic temperature range (DTR) control manager in the management controller; and
employing the DTR control manager to:
monitor one or more of temperature, environmental and workload conditions to determine that the IO link may be approaching a marginal operating condition; and
trigger the at least one of retraining and recalibrating of the IO link without resetting the IO link.

29. The method of claim 21, wherein the method is implemented on a platform including the processor coupled to a management controller that is coupled in communication via an out-of-band channel with a second platform on which at least one of an orchestrator and data center management software is implemented, further comprising:
implementing a dynamic temperature range (DTR) control manager in the management controller;
receiving, at the management controller, one of a user initiated, application initiated, or predictive IO link retraining request from the orchestrator or data center management software; and
in response to receiving the user initiated, application initiated, or predictive IO link retraining request, triggering, via the DTR control manager, the at least one of retraining and recalibrating of the IO link without resetting the IO link.

30. The method of claim 21, wherein the IO interface is a Peripheral Component Interconnect Express (PCIe) interface and the device is a PCIe device, and wherein triggering the at least one of retraining and recalibrating of the IO link without resetting the IO link comprises:
receiving, at the processor, a link retraining request comprising ACPI (Advanced Configuration and Power Interface) Source Language (ASL); and
parsing the ASL and setting a register value in the PCIe interface to cause the PCI interface to initiate at least one of link retraining and recalibration.

31. A computing platform comprising:
a host processor, including first and second (IO) interfaces;
an IO device, coupled to the first IO interface via a first IO link;
a management controller, coupled to the second IO interface via a host to management controller interface and configured to:
monitor a processor temperature T_{T} at which the first IO link was trained;
monitor a current temperature T_{C} of the processor;
determine a difference between T_{T} and T_{C} is greater than a current dynamic temperature range threshold DTR_{TH}; and
send a link retraining request to the host processor via the host to management controller interface to trigger at least one of retraining and recalibrating the first IO link.

32. The computing platform of claim 31, wherein the management controller is further configured to:
set T_{T} to T_{C};
set the current value of DTR_{TH} to a prior value or new value;
monitor T_{C};
determine whether the difference between T_{T}−T_{C} is greater than the current DTR_{TH}; and
send a second link retraining request to the host processor via the host to management controller interface to trigger a second at least one of retraining and recalibrating the first IO link.

33. The computing platform of claim 31, wherein the first IO interface is a Peripheral Component Interconnect Express (PCIe) interface and the IO device is a PCIe device, wherein the second IO interface is configured to support ACPI (Advanced Configuration and Power Interface) Source Language (ASL), and wherein the processor is further configured to:
receive a link retraining request including ASL code; and
parse the ASL code and set a register value in the PCIe interface to cause the PCIe interface to initiate at least one of link retraining and recalibration.

34. The computing platform of claim 31, wherein the computing platform is deployed in a data center and the management controller is coupled in communication via an out-of-band channel with a second platform on which at least one of an orchestrator and data center management software is implemented, wherein the computing platform includes one or more IO interfaces including the first IO interface respectively coupled to one or more IO devices including the first IO device via one or more respective IO links including the first IO link, and wherein the management controller is further configured to:
receive one of a user initiated, application initiated, or predictive IO link retraining request from the orchestrator or data center management software to retrain a specified one or the one or more IO links; and
in response to receiving the user initiated, application initiated, or predictive IO link retraining request, send a link retraining request to the host processor via the host to management controller interface to trigger at least one of retraining and recalibrating the specified IO link.

35. The computing platform of claim 31, wherein the processor is further configured to:
in response to receiving the link retraining request,
monitor a link utilization level; and
when the link utilization level falls below a threshold, initiate at least one of retraining and recalibrating the first IO link.

36. The computing platform of claim 31, wherein the processor is one of a Graphic Processor Unit (GPU), General Purpose GPUs (GP-GPU), Tensor Processing Unit (TPU), Data Processor Unit (DPU), Artificial Intelligence (AI) processor, AI inference unit, or Field Programmable Gate Array (FPGA).

37. A management controller, configured to be implemented in a computing platform including a host processor having a first input-output (IO) interface to which a first device is coupled via a first IO link and a host processor to management controller interface via which the management controller is coupled to the processor, the management controller further configured to:
obtain a processor temperature T_{T} at which the first IO link was trained;
monitor a current temperature T_{C} of the processor;
receive or access a first dynamic temperature range threshold DTR_{TH};
determine the difference between T_{T} and T_{C}>DTR_{TH}; and
send a link retraining request to the host processor via the host to management controller interface to trigger at least one of retraining and recalibrating the first IO link.

38. The management controller of claim 37, further configured to:
reset T_{T} to T_{C};
receive or access a second DTR_{TH};
monitor T_{C};
determine whether a difference between T_{T} and T_{C} is greater than the second DTR_{TH}; and
send a second link retraining request to the host processor via the host to management controller interface to trigger a second at least one of retraining and recalibrating the first IO link.

39. The management controller of claim 37, wherein the first IO interface is a Peripheral Component Interconnect Express (PCIe) interface and the IO device is a PCIe device, wherein the second IO interface is configured to support ACPI (Advanced Configuration and Power Interface) Source Language (ASL), and wherein the processor is further configured to:
receive a link retraining request including ASL code; and
parse the ASL code and set a register value in the PCIe interface to cause the PCIe interface to initiate at least one of link retraining and recalibration.

40. The management controller of claim 37, wherein the computing platform is deployed in a data center and the management controller is coupled in communication via an out-of-band channel with a second platform on which at least one of an orchestrator and data center management software is implemented, wherein the computing platform includes one or more IO interfaces including the first IO interface respectively coupled to one or more IO devices including the first IO device via one or more respective IO links including the first IO link, and wherein the management controller is further configured to:
receive one of a user initiated, application initiated, or predictive IO link retraining request from the orchestrator or data center management software to retrain a specified one or the one or more IO links; and
in response to receiving the user initiated, application initiated, or predictive IO link retraining request, send a link retraining request to the host processor via the host to management controller interface to trigger at least one of retraining and recalibrating the specified IO link.
